(19) United States
(12) Patent Application Publication
(10) Pub. No.: US 2017/0255866 A1
(43) Pub. Date: Sep. 7, 2017

(54) ARCHITECTURES AND MECHANISMS FOR PROVIDING ANALYSIS OF COMPLEX OBJECT STRUCTURES

(71) Applicants: Canice Lambe, Co. Dublin (IE); Donal Daly, Cork (IE); Tammy Billington-Dynes, Co. Wicklow (IE); Stephen Roden, Dublin (IE)

(72) Inventors: Canice Lambe, Co. Dublin (IE); Donal Daly, Cork (IE); Tammy Billington-Dynes, Co. Wicklow (IE); Stephen Roden, Dublin (IE)

(21) Appl. No.: 15/087,828

(22) Filed: Mar. 31, 2016

Related U.S. Application Data
(60) Provisional application No. 62/303,289, filed on Mar. 3, 2016.

(51) Int. Cl. G06N 5/04; H04L 29/08; G06F 17/30

(52) U.S. Cl. CPC G06N 5/046; G06F 17/30289; H04L 67/02

(57) ABSTRACT

Techniques and architectures for analyzing a complex set of objects with a set of rules to provide dynamically generated analysis. The complex set of objects is maintained with corresponding relational information. One or more feature vectors corresponding to the complex set of objects are updated. The feature vector provides a flatter representation of the complex set of objects. The one or more feature vectors are transmitted to a remote client computing device.

### TECHNICAL FIELD

Embodiments relate to mechanisms to provide analytical and modeling decision support/coaching tools for complex object structures. More particularly, embodiments relate to mechanisms to provide efficient and streamlined analytical and modeling tools operable on a client device in response to one or more objects and/or triggers from a remote host environment.

### BACKGROUND

As groups and organizations operate within competitive environments, efficient and effective analytical and modeling decision support tools become increasingly important. However, current analytical and modeling tools do not provide optimal functionality.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of a system to provide evaluation and insights based on complex object organizations.

FIG. 2 is an example object tree that can be processed and analyzed as described herein.

FIG. 3 is a block diagram of one embodiment of an architecture that can support asynchronous batch functionality.

FIG. 4 is an interface for an example insight editor that can be used to provide the functionality described herein.

FIG. 5 is an interface for an example rule builder that can be used to provide the functionality described herein.

FIG. 6 provides an example illustration of surfacing insights for an opportunity.

FIG. 7 is an example user interface that allows a user to access various domains within an environment.

FIG. 8 is an example user interface within the opportunity domain.

FIG. 9 is an example user interface for listing insights within the large opportunity scope.

FIG. 10 is an example user interface for editing and/or defining an insight.

FIG. 11 is an example user interface for editing and/or defining coaching advice.

FIG. 12 is an example user interface for editing rule logic.

FIG. 13 is an example user interface to provide an activated rule in context.

FIG. 14 is an example user interface in which opportunity characteristics can be provided and/or updated.

FIG. 15 is an example user interface to provide an activated rule in context in response to the update performed in FIG. 14.

FIG. 16 is an example user interface with an example email summary providing insights as described herein.

FIG. 17 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

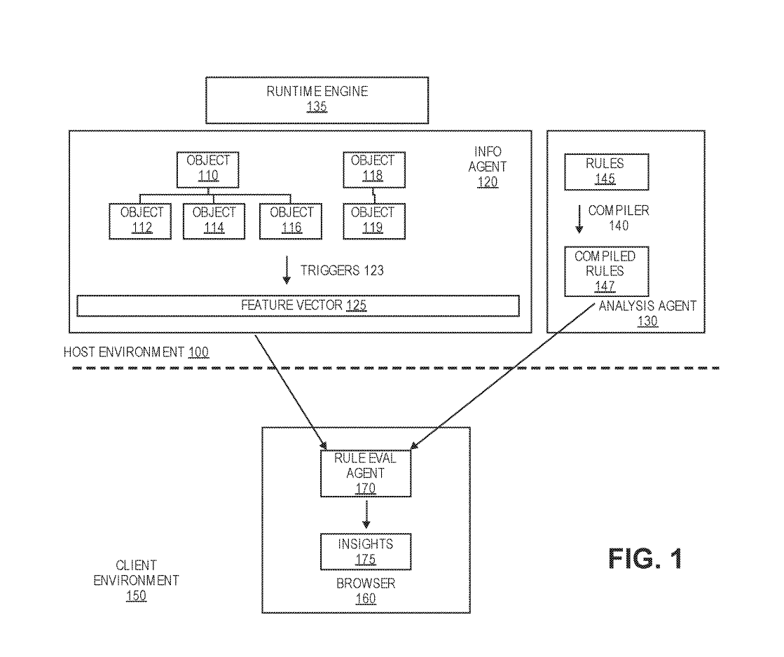

FIG. 1 is a block diagram of one embodiment of a system to provide evaluation and insights based on complex object organizations. The example of FIG. 1 is described in terms of a host environment and a client environment. In alternate embodiments, the host environment and client environment can be combined.

In the example of FIG. 1, host environment 100 represents a collection of one or more computing devices (e.g., hardware server devices) and associated memory that operate together to provide the functionality described herein. Host environment 100 can be, for example, a multitenant environment that supports multiple tenants by providing a single instance of a software platform running on one or more computers to serve multiple tenants. A tenant is generally a group of users who share common access with specific privileges to the software instance. An example of a multitenant architecture is a software as a service (SaaS) platform such as those provided by, for example IBM, MICROSOFT, SALESFORCE, SAP or ORACLE. The trademarks used herein are the property of the respective owners.

In one embodiment, host environment 100 includes runtime engine 135, which provides various functions including enforcing limits to, for example, ensure that executed code or processes do not consume excessive resources. In one embodiment, if executed code exceeds a limit, runtime engine 135 can issue an exception (or trigger some other response) to address the excessive resource consumption. Runtime engine 135 can enforce one or more of the following types of limits: per-transaction code limits, per-transaction package limits, platform limits, static limits, size-specific limits and/or other miscellaneous limits.

In one embodiment, per-transaction code limits count the total number of transactions to be performed in response to executing the code. These transactions can include, for example, a number of database queries issued, a number of records retrieved, a number of callouts, a stack depth, a number of jobs added to a queue, a heap size, processor consumption, execution time, a number of push notifications triggered, etc. In one embodiment, per-transaction package limits can include, for example, a total heap size, a maximum processor consumption, a maximum transaction execution time, a maximum number of unique namespaces, etc.

In one embodiment, platform limits can include, for example, a maximum number of method executions, a number of concurrent requests, a number of classes scheduled concurrently, a maximum number of batch jobs, a maximum number of test classes, a maximum number of requests to URLs, etc. In one embodiment, static limits can include, for example, a default timeout for callouts, a maximum size for a callout request, a query run time, a loop list batch size, a maximum number of record returned for a batch query, etc.

In one embodiment, size-specific limits include, for example, a number of characters for a class, a number of characters for a trigger, a maximum code size, a method size limit, etc. In one embodiment, miscellaneous limits can include, for example, query performance parameters, social media rate limits, event report limits, inbound and/or outbound email limits, etc.

In one embodiment, client environment 150 represents a computing platform utilized by a user or tenant of host environment 100. Client environment can be provided, for example, as a laptop computer, a desktop computer, a table, a smartphone, a wearable computing device, a kiosk, a point of sale (POS) terminal, etc. In one embodiment, client environment 150 provides a user interface and the functionality described herein via browser 160; however, other interfaces can also be supported. A browser is a software application that provides the ability to retrieve, present and/or otherwise utilize information available via a computer network (not illustrated in FIG. 1). Information can be identified and/or navigated by, for example, uniform resource identifiers (URIs), hyperlinks, etc. Various browsers are known in the art.

In one embodiment, host environment 100 includes information agent 120 and analysis agent 130. Host environment 100 can include additional agents/components as well. In one embodiment, information agent 120 functions to create and/or maintain organizations of objects (e.g., 110, 112, 114, 116, 118, 119) that can have interrelationships (e.g., parent-child, sibling, dependencies) that are supported by information agent 120. In one embodiment, information agent 120 includes at least one instance of a database and database management system (DBMS), which can include, for example, MySQL, Oracle, IBM DB2, Microsoft SQL Server, etc.

In one embodiment, in response to one or more triggers 123, information agent 120 creates and/or updates feature vector 125. In one embodiment, triggers 123 includes at least a trigger based on a change to one of the objects maintained by information agent 120. In one embodiment, triggers 123 includes at least a trigger based on addition of a new object to the objects maintained by information agent 120. In one embodiment, triggers 123 are implemented utilizing the Apex programming language; however, other implementations can also be supported. Apex is an on-demand programming language that provides features for building business applications including data models and objects to manage data, workflow and collaboration management and user interface (UI) models.

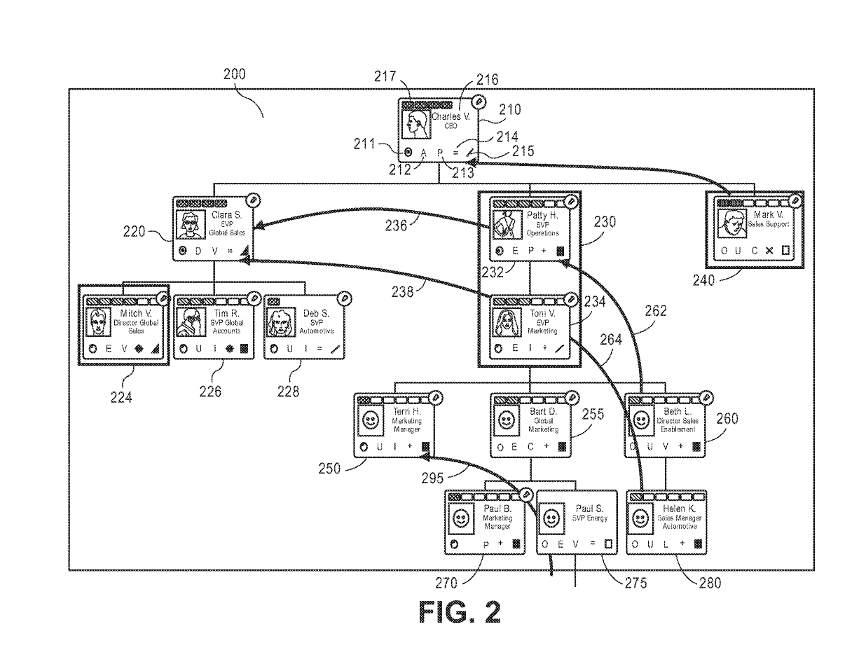

In one embodiment, in response to a triggering event, information agent 120 selects data from the objects maintained and modifies/creates feature vector 125. In one embodiment, feature vector 125 is a flat (or flatter) representation of a more complex organization of objects 110, 112, 114, 116, 118 and 119. Any number of objects can be supported. In one embodiment, feature vector 125 includes a subset of characteristics for one or more of the objects. FIG. 2 provides a more specific example. In on embodiment, a subset of objet can be represented in feature vector 125.

In general, a flat file or a flat representation is one in which records to not have a structured interrelationship. In one embodiment, structure characters and/or markup is absent. Examples include text files, comma-separated values (CSV) files and delimited files. In alternate embodiments, other flat formats, for example, a two-dimensional table can be utilized.

In one embodiment, host environment 100 can also include analysis agent 130, which further includes rules 145, compiler 140 and compiled rules 147. In one embodiment, analysis agent 130 operates to collect/gather/receive rules 145 and compile the rule (e.g., via compiler 140) to a set of compiled rules 147. In one embodiment compiled rules 147 are JavaScript representations of rules 145. Other representations can also be supported.

In the example of FIG. 1, as the number of objects grows, the complexity of the corresponding analysis also grows. The system may be required to evaluate hundreds of rules to identify which ones will fire and which ones will not. Performing this evaluation on the server side within host environment 100 can result in extremely slow performance. Further, under certain conditions, evaluation may be restricted, limited and/or stopped based on resource sharing parameters of host environment 100. For example, in a multitenant environment, one tenant is generally not allowed to consume a disproportionately large portion of the available resources (e.g., processor cycles, cache lines, memory locations, I/O bandwidth).

In one embodiment, in order to overcome these restrictions, feature vector 125 and compiled rules 147 are provided to client environment 150 for local evaluation. This can provide for relatively fast and efficient execution and scales very well. In one embodiment, client environment 150 utilizes browser 160 to acquire feature vector 125 and compiled rules 147. In one embodiment, browser 160 includes rule evaluation agent 170 to apply compiled rules 147 to feature vector 125. Rule evaluation agent 170 can be, for example, a browser plugin or extension or other mechanism for providing additional functionality to browser 160. As another embodiment, browser 160 can include, as part of the browser functionality, rule evaluation agent 170. In an alternate embodiment, rule evaluation agent 170 can be part of client environment 150, while not being part of browser 160.

In one embodiment, rule evaluation agent 170 applies the rules to the features of feature vector 125 to provide one or more insights 175. Various example insights are described in greater detail below. In one embodiment, insights 175 are presented to a user via a graphical user interface (GUI) corresponding to browser 160. In other embodiments, insights 175 can be presented as electronic mail, spreadsheet files, social media posts, etc. Further, insights 175 can have one or more associated action. For example, if the insights 175 indicate a dangerous condition exists, an alarm can be triggered. As another example, if insights 175 indicate that a follow-up opportunity is approaching, a reminder email can be sent and/or a calendar entry can be generated.

FIG. 2 is an example object tree that can be processed and analyzed as described herein. The example of FIG. 2 is a political organization structure that may be utilized, for example, as part of a customer relationship management (CRM) environment.

In the example of FIG. 2, org chart 200 provides a graphical representation of various individuals within an organization. In one embodiment, each individual can correspond to one of the objects in FIG. 1. In another embodiment, each characteristic within org chart 200 can have a corresponding object as illustrated in FIG. 1. Thus, the interrelationships between objects can be complex. While various characteristics and mappings are illustrated in the example of FIG. 2, any number of objects and corresponding relationships between the objects can be supported.

In the example of FIG. 2, node 210 can represent a head node, which can include, for example, a name, title and picture for the corresponding individual (216). In one embodiment, each individual can have an indication of their degree of power (211), role in the relevant process (212), level of support that individual provides (213) and/or the level of contact that individual has had with the monitored process (214). In one embodiment, each individual can have a corresponding summary based on the factors above (215) and a graphical representation of the individual's involvement and influence in the organization (217).

In one embodiment, org chart 200 includes reporting structures. For example, 220, 232 and 240 report to 210. Similarly, 224, 226 and 228 report to 220. In one embodiment, box 230 around individuals 232 and 234 can indicate key players in the transaction. Individuals 250, 255, 260, 270, 275 and 280 are designated as reporting to one or both of the key players. In one embodiment, influence lines 262, 264, 236, 238 and 295 indicate influential relationships that are not necessarily captured by the reporting structure described above.

In the example of FIG. 2 and using the rule creation and analysis tools described herein, a business user (that can be part of a tenant in a multitenant environment) can add “insights” or “business rules” within certain domains (e.g., opportunity management) so that those insights trigger (or fire) when appropriate and, in doing so, provide guidance or other useful information to users within the domain. While many of the examples provided herein are related to sales and CRM functionality, the concepts and architectures described herein are more broadly applicable.

For example, in a complex business-to-business (B2B) sales environment there are many different considerations in determining the likelihood of winning the deal, which can include one or more of: 1) customer urgency to act; 2) the degree to which the key players/decision makers are engaged; 3) the relative preference of the key player for sales individuals and their solutions; 4) the degree to which the provided solution is differentiated as compared to the competition; and/or 5) the competitive strategy utilized.

In managing the opportunity, a domain expert could follow one or more guidelines when managing the opportunity including, for example, if there is no compelling reason for the customer to act then do not try to close the opportunity (instead work with supporters in the account to further develop the business case) and/or if the sales team is stronger on certain criteria but weaker on others, then seek to adjust the buying criteria so be more favorable to the offered solution (or alternatively try to fragment the deal to compete for a part of the opportunity).

The tools provided herein can be used, for example, as a coaching service to provide insights/rules/guidelines to provide support for less experienced users as they manage deals. In one embodiment, a domain expert (or other individual) can work in a what-you-see-is-what-you-get (WYSIWYG) environment to build and/or test insights without support from a more technical resource. In one embodiment, insights are provided to an end user in context with that user's domain. For example, if the end user is viewing an opportunity page within a multitenant CRM environment for an opportunity, then any insights pertaining to that opportunity display to the appropriate users at the appropriate time within the appropriate domain. In one embodiment, the insight(s) is/are pulled as the context is established by the user visiting a page via, for example, a browser.

In one embodiment, the insights can be pushed to an end user (e.g., a weekly digest) in addition to/instead of being pulled. In the push configuration, the system is performing the analysis in the background on behalf of the user and brings items of note to the user's attention. This can be useful, for example, in a domain in which there is occasional usage and/or low user adoption of the solution.

Thus, the architectures described herein support one or more of the following. Insights and/or rules that can be provided by a domain expert (or other user) can be captured in a WYSIWYG environment. That is, insights and/or rules can be utilized without technical programming experience. These insights fire in context for end users as they engage with the system (e.g., a CRM system). In one embodiment, insights can be pushed to users via electronic mail and/or social media platforms (e.g., TWITTER, FACEBOOK, LINKEDIN, CHATTER). In one embodiment, the architecture can operate within an on-demand and/or multitenant platform (e.g., a platform as a service (Paas) environment).

In one embodiment, WYSIWYG editing of rules is supported so that a domain expert (or other individual) is presented with or can generate a “signal list” or “data dictionary” of features or characteristics with which to build rules. In one embodiment, the ability to push results corresponds to asynchronous processing of insights within a host environment (e.g., 100 in FIG. 1). In one embodiment, the domain characteristics that are analyzed adhere to a flat vector model where the domain is represented by a flat list of attributes (or signals). Thus, a complicated nested data structure (e.g., as illustrated in FIG. 2) can be condensed into a flat feature vector (e.g., 125 in FIG. 1).

In the example of FIG. 2, the org chart provides a view of people involved in the buying decision. In that example, each person has specific attributes (e.g., degree of power/influence; level of support/non-support; role in the buying process—evaluator, decision maker, approver; level of contact). In the example of FIG. 2, person 224 (i.e., Mitch) has the following attributes: degree of power=political structure; role=evaluator; level of support=mentor; level of contact=multiple. Further, in the example of FIG. 2, person 240 (i.e., Mark) has the following attributes: degree of power=outside political structure; role=user; level of support=enemy; level of contact=none. Thus, even with the relatively simple example of FIG. 2, over ten contacts with four or more attributes, each of which can have one of three or more values, as well as relationships between the contacts, quickly results in a complex structure.

When analyzing a complex structure like this, a domain expert (or other party) can look for certain combinations of characteristics. For example, whether there is a mentor and how influential that person is within the organization. As another example, whether anyone is considered an enemy and how influential that person is within the organization, or what is the level of contact with the key players. Many other criteria sets can be supported.

As an example of possible analysis, when combining the organization/political map with opportunity management information, a user can determine things like, how does the seller's solution perform on issues that the key players care about, or how are the key player concerns reflected in the current structure. In one embodiment, each time one or more of these characteristics or factors is modified or added, the map of objects (e.g., FIG. 2) is updated and the information agent (e.g., 120 in FIG. 1) can update the corresponding feature vector(s).

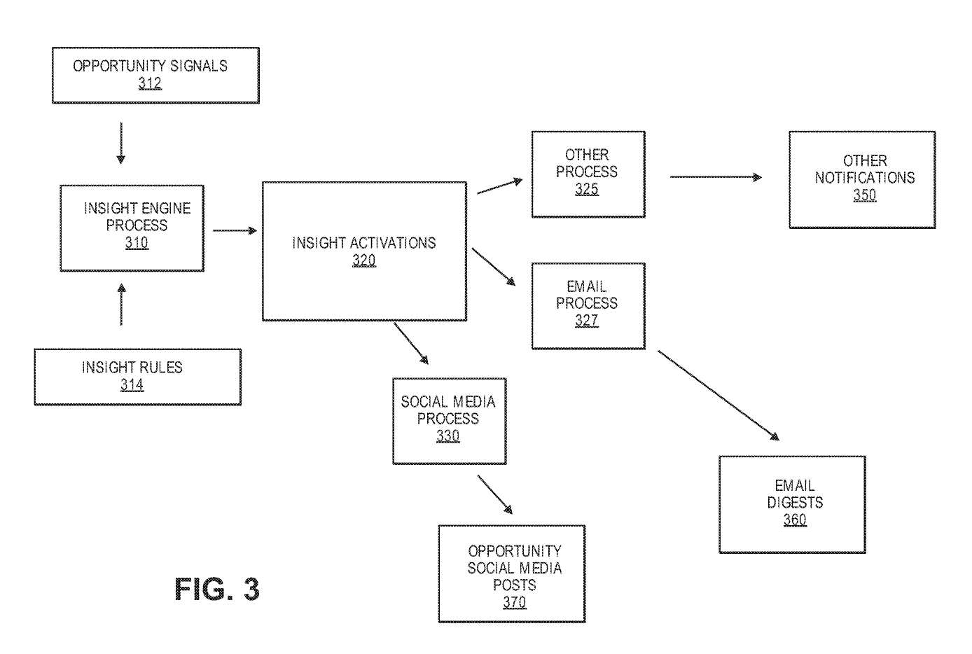

FIG. 3 is a block diagram of one embodiment of an architecture that can support asynchronous batch functionality. In one embodiment, insight engine 310 resides within a server computing device, for example, within a multitenant environment. Insight engine 310 can be configured to process opportunity signals 312 and insight rules 314 to perform analytical functionality as described herein. Opportunity signals 312 can be, for example, a feature vector as described above. Insight rules 314 can be, for example, the compiled rules as described above.

In one embodiment, in response to processing opportunity signals 312 and insight rules 314, insight engine 310 generates insight activations 320, which are a set of one or more actions to be taken as a result of the analysis of opportunity signals 312 utilizing insight rules 314. In one embodiment, insight activations 320 can control/initiate/trigger one or more processes depending on the results of the analysis. The example of FIG. 3 provides social media process 330, email process 327 and other process 325; however, any number of processes can be supported.

In one embodiment, social media process 330 provides one or more opportunity social media posts 370, which can be, for example, suggestions, updates, motivations and/or any other type of social media post related to the analysis/insights provided by insight engine 310. Similarly, email process 327 can provide one or more email messages (or digests) 360, which can be, for example, suggestions, updates, motivations and/or any other type of message related to the analysis/insights provided by insight engine 310. Other process 325 provides other types of notifications 350, for example, SMS messages, instant messaging (IM) messages, windows, etc.

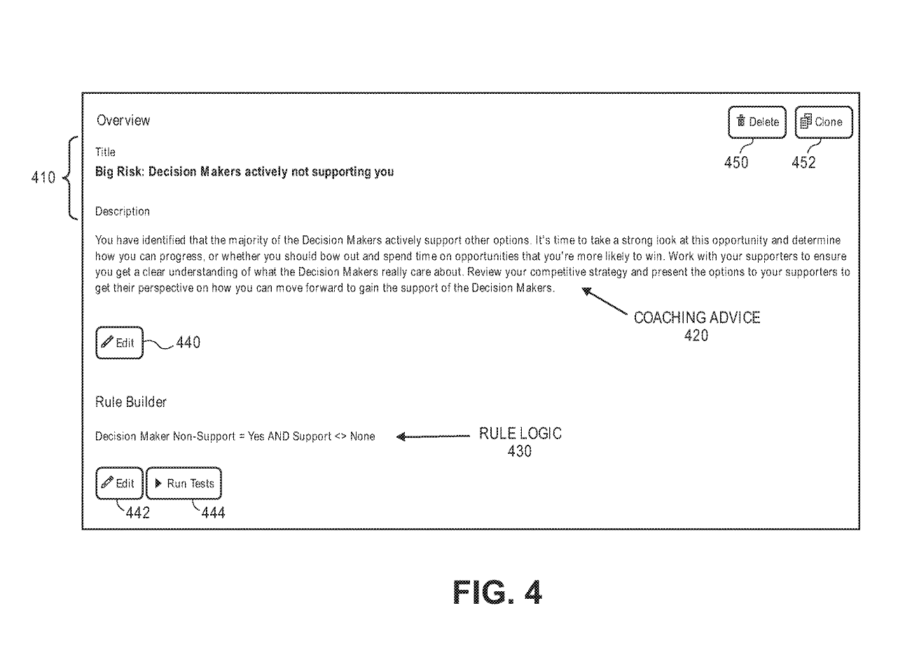

FIG. 4 is an interface for an example insight editor that can be used to provide the functionality described herein. In one embodiment, a domain expert (or other user) uses the “Insight Editor” to build rules based on the signal set. For example:
IF<Mentor>=“Key Player” AND <Key Player Contact>=“Limited” THEN SAY:
   “Although you have a powerful ally in the account your overall coverage of the key players is less than ideal. Work with your mentor to gain access to the other key players.”

The example interface of FIG. 4 allows the creation of such rules in a WYSIWYG fashion. In one embodiment, each rule can have a title (e.g., 410) and a custom description (e.g., 420), which can also be referred to as coaching advice. Coaching advice can be any advice or guidance that a rule designer wishes to provide in response to a set of conditions. The set of conditions can be defined via rule logic 430.

In one embodiment, the example interface of FIG. 4 provides the ability to edit and/or test coaching advice 420 and rule logic 430 via one or more buttons (e.g., 440, 442, 444) or other mechanisms included in the interface. In one embodiment, the rule can be deleted, copied and/or edited via one or more buttons (e.g., 450, 452) or other mechanisms included in the interface.

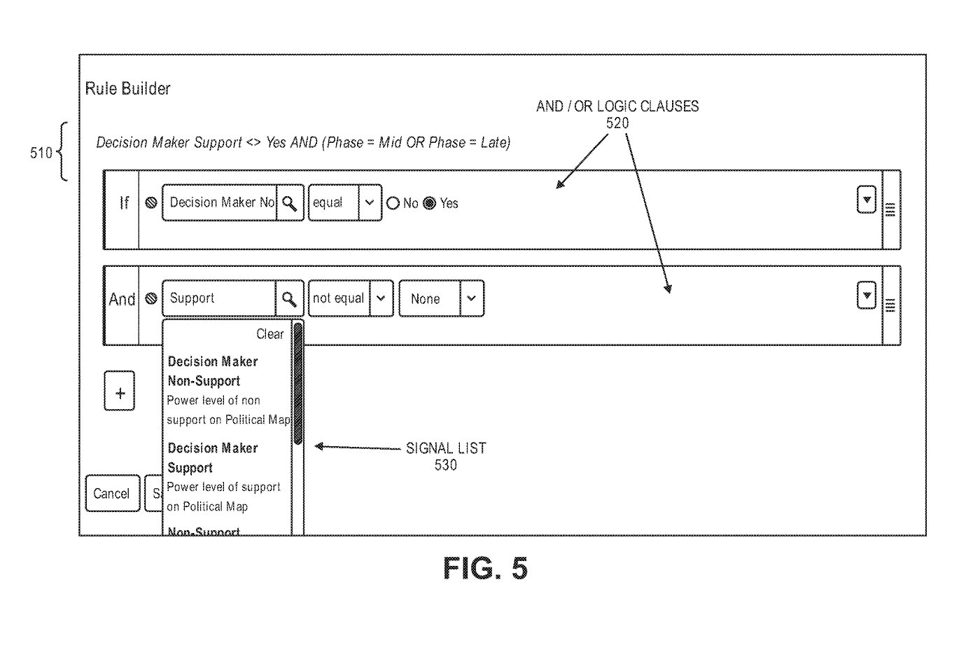

FIG. 5 is an interface for an example rule builder that can be used to provide the functionality described herein. In one embodiment, a domain expert (or other user) uses the “Rule Builder” to build rules based on the signal set.

In one embodiment, the rules break out into the “Rule Logic” which determines if the rule should be fire and the “Coaching Advice” which provides insight and advice based on the situation. In one embodiment, the rule builder provides current rule 510, which is the rule being constructed/edited. In one embodiment, using a page within the Insight Editor can create such rules and edit the rule logic using, for example, AND/OR logic clauses 520. Additional types of logic (i.e., beyond AND and OR) can also be supported. In one embodiment, the rule builder interface provides signal list 530 from which to select when building rules. In one embodiment, signal list 530 is built from the feature vector described above. That is, in one embodiment, the signals available from signal list 530 are obtained from the feature vector (e.g., feature vector 125 of FIG. 1).

In one embodiment, these rules are stored in Custom Objects (e.g., within the Salesforce environment). Creates and updates via the UI can update these rules directly. In one embodiment, when saving the rule definitions to the custom objects, the host environment and/or information agent also constructs a JavaScript representation of the rule.

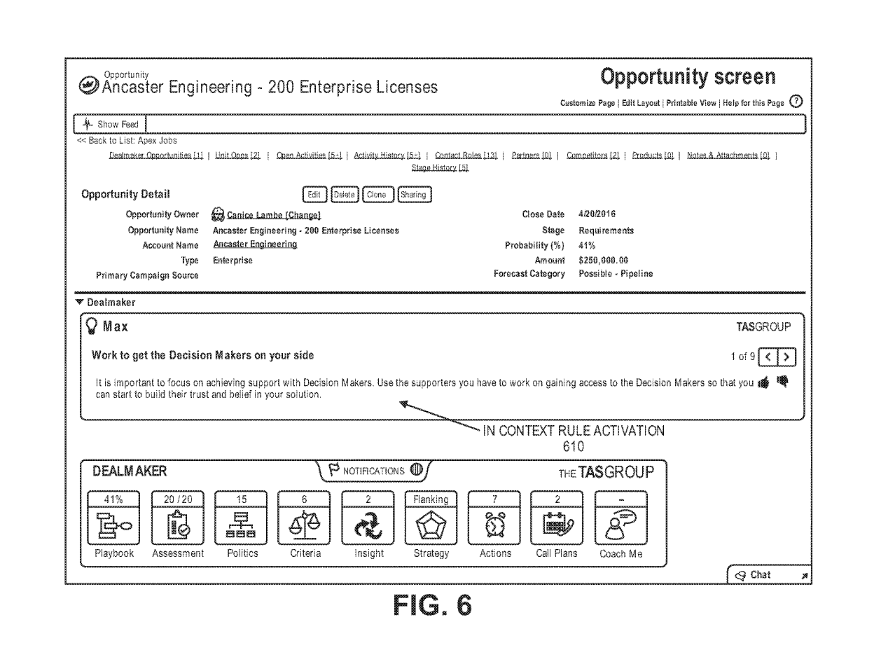

In one embodiment, with the signals enabled and the insight rules in place, the architecture can be configured to evaluate the rules dynamically as a user views and interacts with the domain. FIG. 6 provides an example illustration of surfacing insights for an opportunity.

In one embodiment, when an end user visits an instance of an object for which these features have been activated (an opportunity in this case) the system can evaluate the candidate set of rules against the feature vector of signals to identify which rules fire. In one embodiment, the resulting rule activations are displayed in a panel (e.g., one at a time) where the user can view and potentially give feedback or take actions 610.

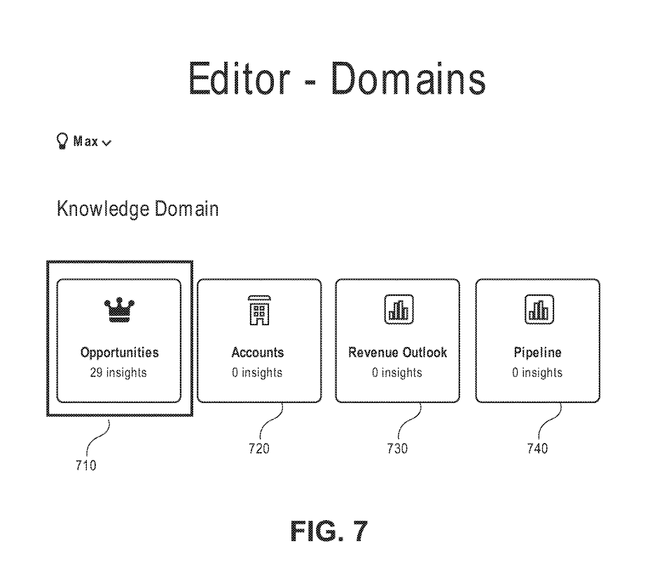

FIG. 7 is an example user interface that allows a user to access various domains within an environment. The example of FIG. 7 includes opportunities 710, accounts 720, revenue outlook 730 and pipeline 740; however, other and/or different domains can also be supported.

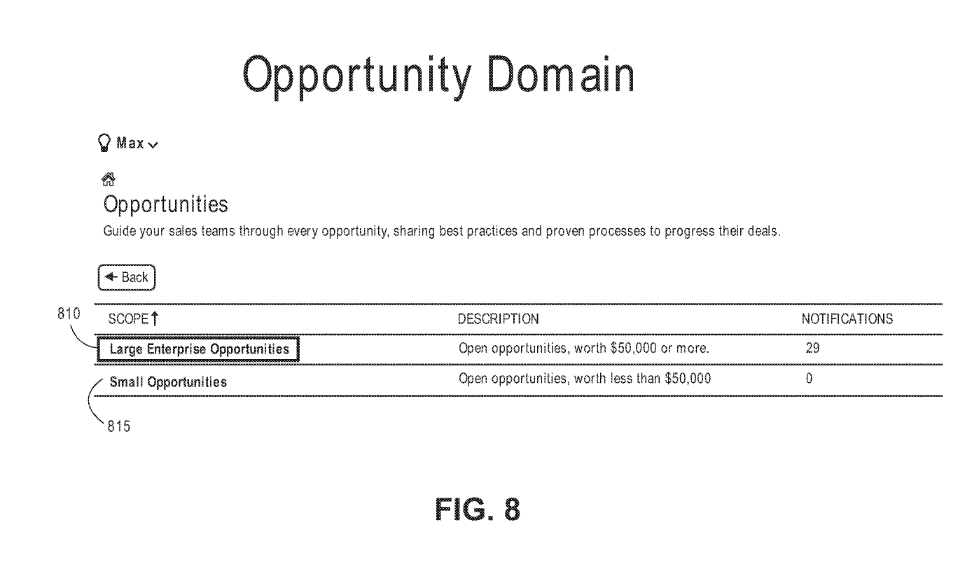

FIG. 8 is an example user interface within the opportunity domain. In the example of FIG. 8, opportunities can be organized by scope (e.g., large enterprise opportunities 810, small opportunities 815); however, other organizations can be provided within the opportunity domain.

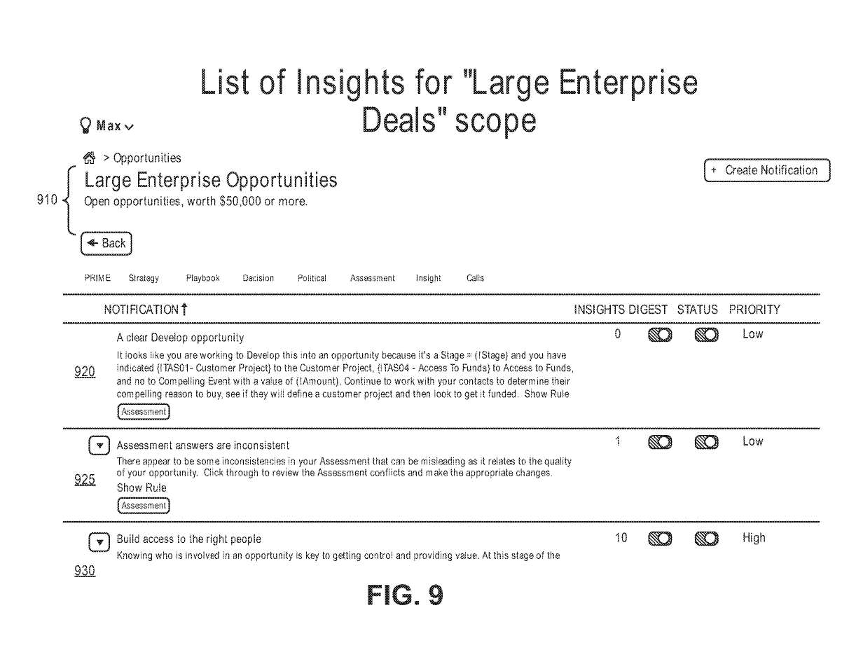

FIG. 9 is an example user interface for listing insights within the large opportunity scope. The user interface can indicate that the insights are provided for large enterprises 910. One or more insights can be provided (e.g., 920, 925, 930) and can be organized in various ways, for example, by status, by priority, etc.

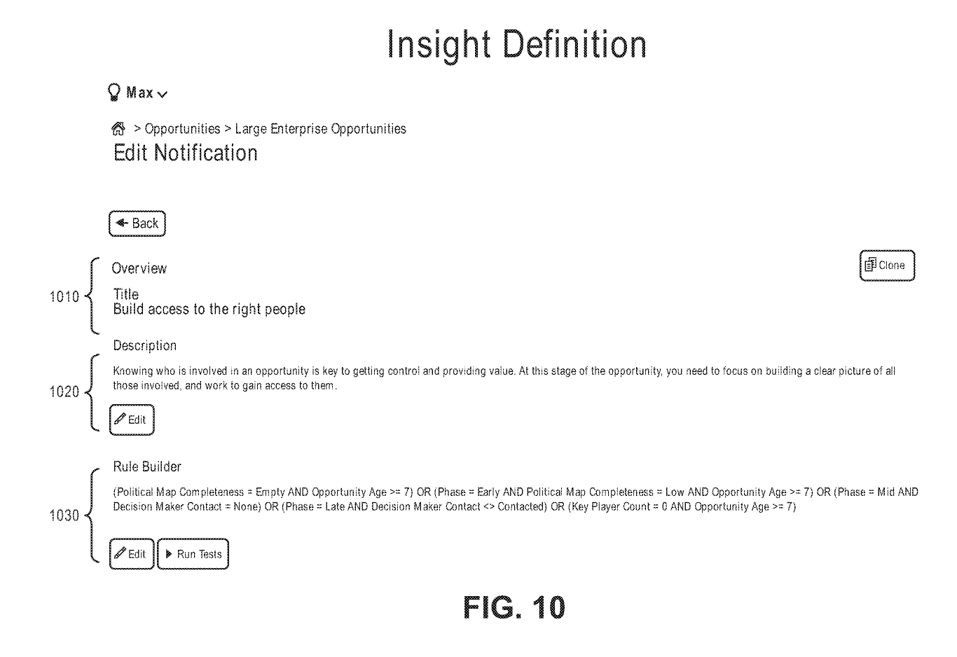

FIG. 10 is an example user interface for editing and/or defining an insight. The user interface of FIG. 10 can provide an overview with title 1010, insight description 1020 and/or rule definition/builder 1030. One or more of these insight components can be editable through the interface of FIG. 10.

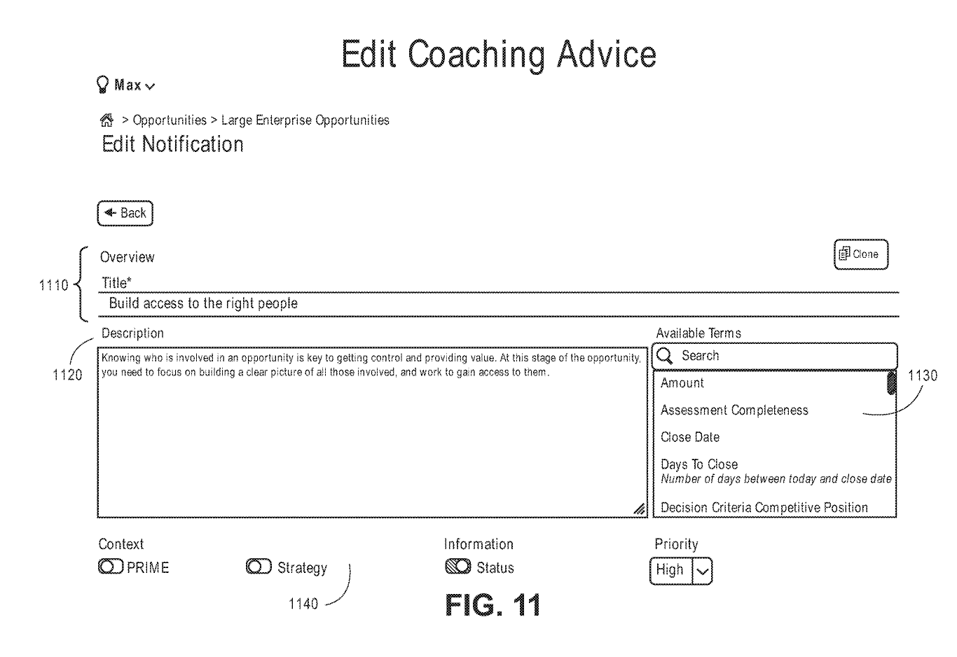

FIG. 11 is an example user interface for editing and/or defining coaching advice. The user interface of FIG. 11 can provide an overview with title 1110, coaching advice description 1120, available relevant terms 1130 and/or context 1140. One or more of these components can be editable through the interface of FIG. 11.

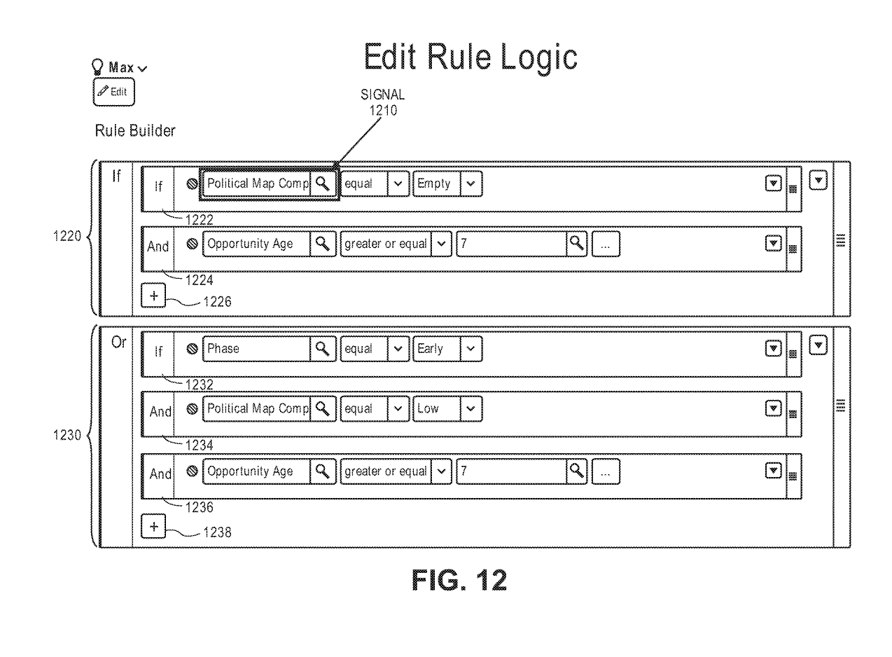

FIG. 12 is an example user interface for editing rule logic. The example of FIG. 12 includes IF section 1220 and OR section 1230, which can be utilized to build the logic of a rule. In one embodiment, each logic operator can be configured to operate against one or more signals (e.g., 1210).

While only one IF and one OR section have been illustrated, rules of any level of complexity can be built utilizing the interfaces and architectures described herein. In the example of FIG. 12, IF clause 1220 further includes IF 1222 and AND 1224. Additional logic elements can also be added via button 1226. Similarly, in the example of FIG. 12, OR clause 1230 further includes IF 1232, AND 1234 and AND 1236. Additional logic elements can also be added via button 1238.

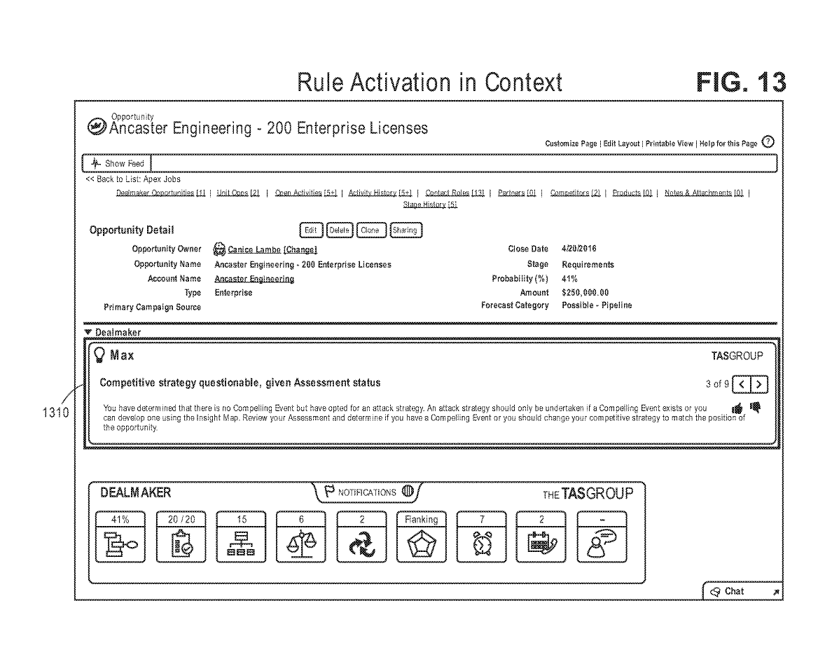

FIG. 13 is an example user interface to provide an activated rule in context. In the example of FIG. 13, one or more rules have been previously implemented, for example, utilizing the interfaces and architectures described above. FIG. 13 provides an example interface in which a user can receive coaching/advice (e.g. 1310) in response to relevant conditions as determined by the active rules.

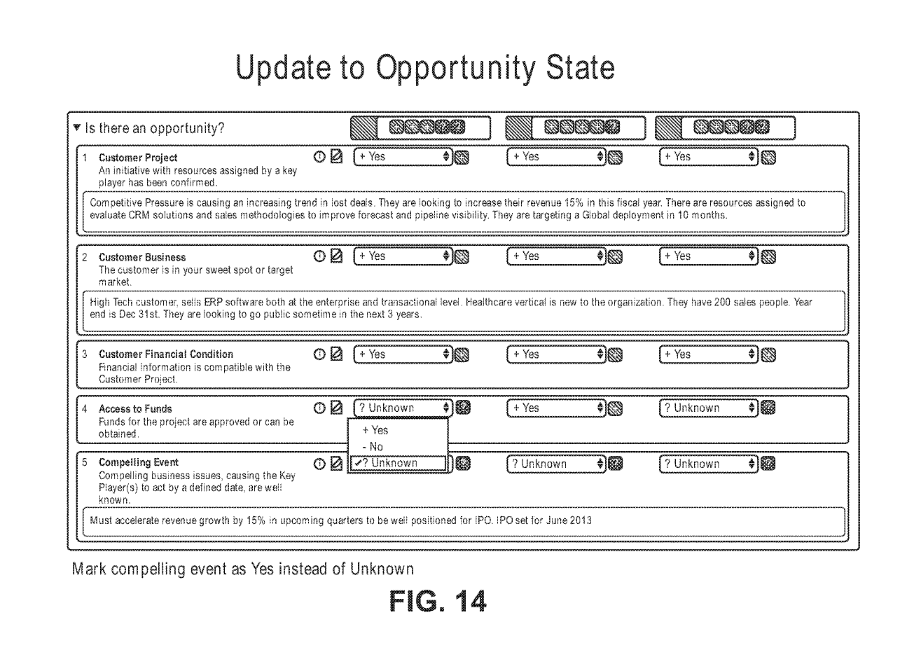

FIG. 14 is an example user interface in which opportunity characteristics can be provided and/or updated. The example of FIG. 14 in one in which a user can change the status of “Compelling Event” from “Unknown” to “Yes.” In the example of FIG. 14, each column has a graphical summary at the top of the column corresponding to the conditions provided for each characteristic in the column.

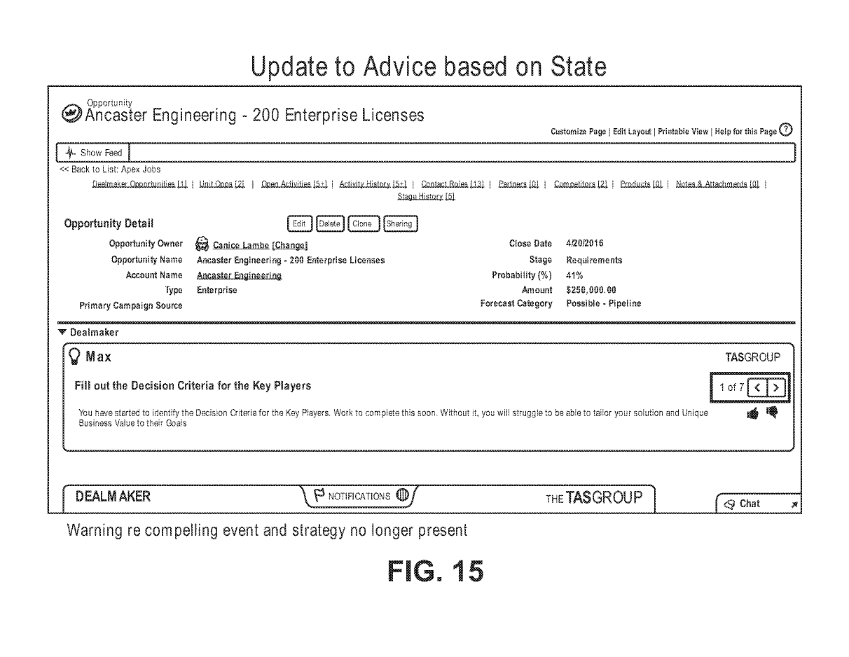

FIG. 15 is an example user interface to provide an activated rule in context in response to the update performed in FIG. 14. In the example of FIG. 15, one or more rules have been previously implemented, for example, utilizing the interfaces and architectures described above. FIG. 15 provides an example interface in which a user can receive coaching/advice in response to relevant conditions as determined by the active rules including the Compelling Event information updated in FIG. 14.

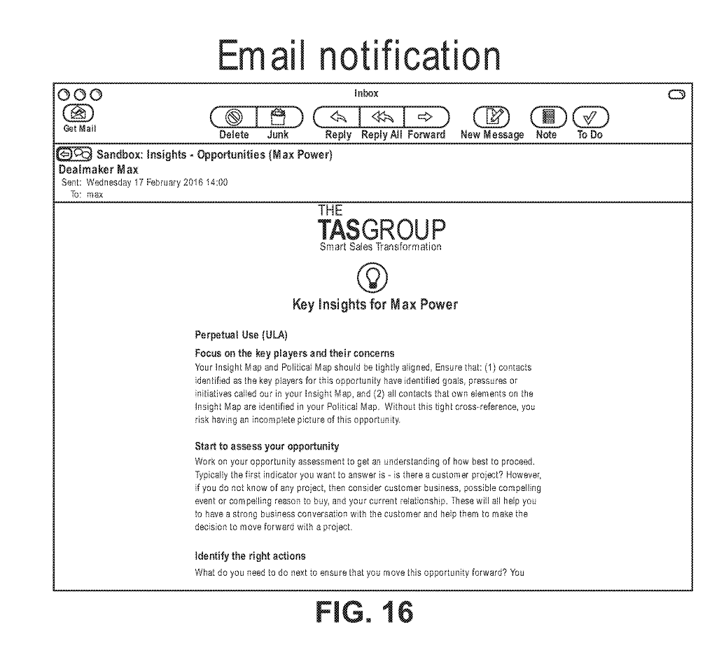

FIG. 16 is an example user interface with an example email summary providing insights as described herein. The email summary can include, for example, one or more insights as described above as well as any other relevant information. The additional information can include, for example, timeline information.

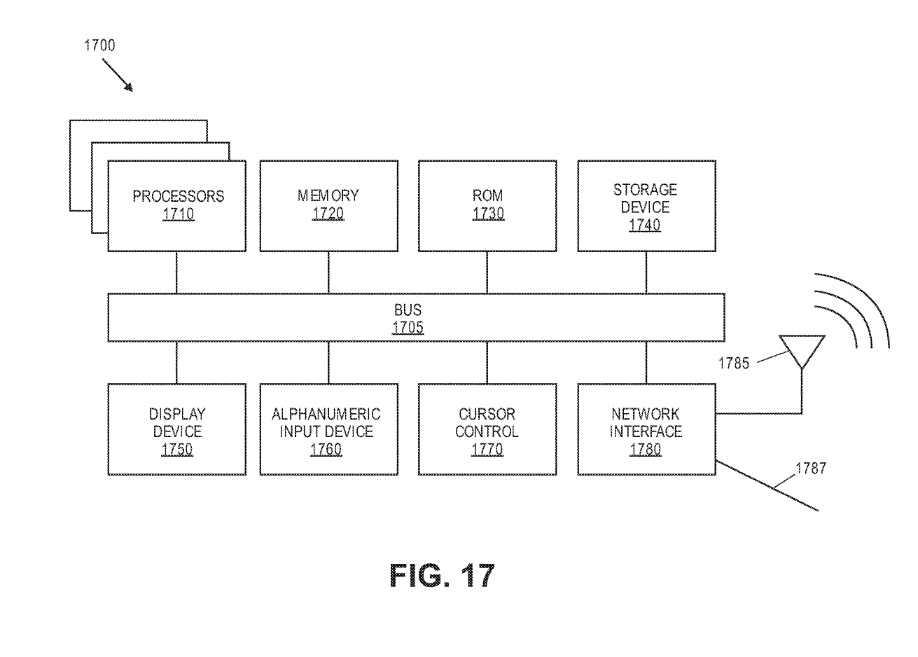

Various embodiments and interfaces can be provided by one or more electronic systems. FIG. 17 is a block diagram of one embodiment of an electronic system. The electronic system illustrated in FIG. 17 is intended to represent a range of electronic systems (either wired or wireless) including, for example, desktop computer systems, laptop computer systems, cellular telephones, smartphones, tablets, wearable computing devices, etc. Alternative electronic systems may include more, fewer and/or different components.

Electronic system 1700 includes bus 1705 or other communication device to communicate information, and processor 1710 coupled to bus 1705 that may process information. While electronic system 1700 is illustrated with a single processor, electronic system 1700 may include multiple processors and/or co-processors. Electronic system 1700 further may include random access memory (RAM) or other dynamic storage device 1720 (referred to as main memory), coupled to bus 1705 and may store information and instructions that may be executed by processor 1710. Main memory 1720 may also be used to store temporary variables or other intermediate information during execution of instructions by processor 1710.

Electronic system 1700 may also include read only memory (ROM) 1730 and/or other static storage device coupled to bus 1705 that may store static information and instructions for processor 1710. Data storage device 1740 may be coupled to bus 1705 to store information and instructions. Data storage device 1740 such as a magnetic disk or optical disc and corresponding drive may be coupled to electronic system 1700.

Electronic system 1700 may also be coupled via bus 1705 to display device 1750, such as a cathode ray tube (CRT) or liquid crystal display (LCD), to display information to a user. Alphanumeric input device 1760, including alphanumeric and other keys, may be coupled to bus 1705 to communicate information and command selections to processor 1710. Another type of user input device is cursor control 1770, such as a mouse, a trackball, or cursor direction keys to communicate direction information and command selections to processor 1710 and to control cursor movement on display device 1750.

Electronic system 1700 further may include network interface(s) 1780 to provide access to a network, such as a local area network. Network interface(s) 1780 may include, for example, a wireless network interface having antenna 1785, which may represent one or more antenna(e). Network interface(s) 1780 may also include, for example, a wired network interface to communicate with remote devices via network cable 1787, which may be, for example, an Ethernet cable, a coaxial cable, a fiber optic cable, a serial cable, or a parallel cable.

In one embodiment, network interface(s) 1780 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 1780 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method for analyzing a complex set of objects with a set of rules to provide dynamically generated analysis, the method comprising:
maintaining, with a host computing environment having at least one processor and at least one memory device, the complex set of objects with corresponding relational information;
updating, with the host computing environment, one or more feature vectors corresponding to the complex set of objects, wherein the feature vector provides a flatter representation of the complex set of objects; and
transmitting the one or more feature vectors to a remote client computing device.

2. The method of claim 1 wherein the updating is performed in response to at least one trigger.

3. The method of claim 2 wherein the at least one trigger comprises at least an update to an object within the complex set of objects.

4. The method of claim 1 further comprising:
receiving, with the host computing environment, one or more rules to be applied to the complex set of objects;
compiling the set of rules to generate a compiled set of rules that comprise a script-based representation of the one or more rules; and
transmitting the compiled set of rules to the remote client computing device.

5. The method of claim 4 wherein the one or more rules to be applied to the complex set of objects is received via a graphical user interface in response to user input.

6. The method of claim 1 wherein the complex set of objects represent data received from multiple users via multiple client computing devices each having access to the host computing environment.

7. The method of claim 1 wherein the host computing environment further provides a multitenant environment in which per-tenant resource limits are enforced.

8. The method of claim 7 wherein the per-tenant resource limits comprise at least one resource rate limit.

9. A non-transitory computer-readable medium having stored thereon instructions that, when executed by one or more processors, are configurable to cause the one or more processors to analyze a complex set of objects by:
maintaining, with a host computing environment having at least one processor and at least one memory device, the complex set of objects with corresponding relational information;
updating, with the host computing environment, one or more feature vectors corresponding to the complex set of objects, wherein the feature vector provides a flatter representation of the complex set of objects; and
transmitting the one or more feature vectors to a remote client computing device.

10. The non-transitory computer-readable medium of claim 9 wherein the updating is performed in response to at least one trigger.

11. The non-transitory computer-readable medium of claim 10 wherein the at least one trigger comprises at least an update to an object within the complex set of objects.

12. The non-transitory computer-readable medium of claim 9 further comprising instructions that, when executed by the one or more processors, cause the one or more processors to:
receive, with the host computing environment, one or more rules to be applied to the complex set of objects;
compile the set of rules to generate a compiled set of rules that comprise a script-based representation of the one or more rules; and
transmit the compiled set of rules to the remote client computing device.

13. The non-transitory computer-readable medium of claim 12 wherein the one or more rules to be applied to the complex set of objects is received via a graphical user interface in response to user input.

14. The non-transitory computer-readable medium of claim 9 wherein the complex set of objects represent data received from multiple users via multiple client computing devices each having access to the host computing environment.

15. The non-transitory computer-readable medium of claim 9 wherein the host computing environment further provides a multitenant environment in which per-tenant resource limits are enforced.

16. The non-transitory computer-readable medium of claim 15 wherein the per-tenant resource limits comprise at least one resource rate limit.

17. A method for providing dynamically generated analysis corresponding to a complex set of objects via a graphical user interface, the method comprising:
receiving, with a client computing device having one or more processors, a feature vector from a remote host environment communicatively coupled with the client computing device, the feature vector providing a flatter representation of a complex object structure accessible by the host environment;
receiving with the client computing device a set of one or more compiled rules;
applying, with the client computing device, the set of one or more compiled rules to the feature vector to dynamically generate one or more insights; and
present, with the graphical user interface of the client computing device, the one or more insights.

18. The method of claim 17 wherein the set of one or more compiled rules is received from the remote host environment.

19. The method of claim 17 wherein the graphical user interface is a user interface of a browser application running on the client computing device.

20. The method of claim 19 wherein the applying the set of one or more compiled rules is performed by a plug-in/extension to the browser.

21. The method of claim 17 wherein the insights are presented via a social media platform.

22. The method of claim 17 wherein the host computing environment further provides a multitenant environment in which per-tenant resource limits are enforced.

23. The method of claim 22 wherein the per-tenant resource limits comprise at least one resource rate limit.

24. A non-transitory computer-readable medium having stored thereon instructions that, when executed by one or more processors, are configurable to cause the one or more processors to provide dynamically generated analysis corresponding to a complex set of objects via a graphical user interface by:
receiving, with a client computing device having one or more processors, a feature vector from a remote host environment communicatively coupled with the client computing device, the feature vector providing a flatter representation of a complex object structure accessible by the host environment;
receiving with the client computing device a set of one or more compiled rules;
applying, with the client computing device, the set of one or more compiled rules to the feature vector to dynamically generate one or more insights; and
present, with the graphical user interface of the client computing device, the one or more insights.

25. The non-transitory computer-readable medium of claim 24 wherein the set of one or more compiled rules is received from the remote host environment.

26. The non-transitory computer-readable medium of claim 24 wherein the graphical user interface is a user interface of a browser application running on the client computing device.

27. The non-transitory computer-readable medium of claim 26 wherein the applying the set of one or more compiled rules is performed by a plug-in/extension to the browser.

28. The non-transitory computer-readable medium of claim 24 wherein the insights are presented via a social media platform.

29. The non-transitory computer-readable medium of claim 24 wherein the host computing environment further provides a multitenant environment in which per-tenant resource limits are enforced.

30. The non-transitory computer-readable medium of claim 29 wherein the per-tenant resource limits comprise at least one resource rate limit.
